(19) United States
(12) Patent Application Publication
(10) Pub. No.: US 2005/0091580 A1
(43) Pub. Date: Apr. 28, 2005

(54) Method and system for generating a Web page

(76) Inventors: Dave Kamholz, Loveland, CO (US); Steve Yonkaitis, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/693,580

(22) Filed: Oct. 25, 2003

(51) Int. Cl. G06F 17/21; G06F 17/24

(52) U.S. Cl. 715/513

(57) ABSTRACT

A method and system for generating a web page is disclosed. Through the use of the present invention, specific content on a web page can be prevented from being indexed by a web crawling mechanism. This is beneficial for web page users the desire specific portions of a generated web page to remain private while at the same time keeping other portions of the web page available to be indexed. The present invention includes a method and system for generating a web page. Accordingly, a first aspect of the present invention is a method for generating a web page. The method includes designating content for publication on the web page and designating a specific portion of the content to prevent a web crawling mechanism from indexing the specific portion.

### FIELD OF THE INVENTION

The present invention relates generally to the field of computerized publishing and knowledge management, and more particularly to a method and system for generating a web page.

### BACKGROUND OF THE INVENTION

There has recently been a tremendous growth in the number of computers connected to the Internet. A client computer connected to the Internet can download digital information from server computers. Client application software typically accepts commands from a user and obtains data and services by sending requests to server applications running on the server computers. A number of protocols are used to exchange commands and data between computers connected to the Internet. The protocols include the File Transfer Protocol (FTP), the Hyper Text Transfer Protocol (HTTP), the Simple Mail Transfer Protocol (SMTP), and the Gopher document protocol.

The HTTP protocol is used to access data on the World Wide Web, often referred to as “the Web.” The Web is an information service on the Internet providing documents and links between documents. It is made up of numerous Web sites located around the world that maintain and distribute electronic documents. A Web site may use one or more Web server computers that store and distribute documents in a number of formats, including the Hyper Text Markup Language (HTML). An HTML document contains text and metadata (commands providing formatting information), as well as embedded links that reference other data or documents. The referenced documents may represent text, graphics, or video.

A Web browser is a client application or, preferably, an integrated operating system utility that communicates with server computers via FTP, HTTP and Gopher protocols. Web browsers receive electronic documents from the network and present them to a user.

The term “search engine” is often used generically to describe both true search engines and directories, although they are not the same. Search engines typically create their listings automatically by “crawling” the Web. A directory, on the other hand, depends on humans for its listings, i.e., a person submits a short description for an entire site or editors write a description for sites they review. The present invention is particularly suited (although not necessarily limited) for use in a search engine of the type that gathers information automatically, i.e., by “crawling” the Web.

Search engines typically include a “crawler” (also called a “spider” or “bot”) that visits a Web page, reads it, and then follows links to other pages within the site. The crawler returns to the site on a regular basis to look for changes. Everything the crawler finds goes into an index, which is another part of the search engine. The index is like a file or container holding a copy of every Web page that the crawler finds. If a Web page changes, then the index is updated with new information. The search engine software, which is yet another part of the search engine, is a program that sifts through the pages recorded in the index to find documents fulfilling a search query submitted by a user. The search engine software will typically rank the matches in accordance with their relevance.

Once it is given a set of start addresses and restriction rules, a crawler can retrieve documents following all recursive links from the documents that correspond to the start addresses that pass the restriction rules. The primary application of the crawler is to build an index of a set of documents, so that the index can be searched by end-users that want to locate documents that match certain search criteria.

As access to information becomes so easily attainable, privacy on the Internet has become an increasingly important issue. Protecting personal information such as e-mail addresses, phone numbers, etc. has become a challenge to web publishers since the above-described bots can be utilized to pull information off web pages to create mailing lists and contact databases.

Currently, the World Wide Web Consortium (W3C) has published the HTML 4.01 reference. Within this reference, there is support for meta tags that specifically prevent these bots from indexing a web page. However, these meta tags prevent the entire web page from being indexed. This is problematic in instances where a web publisher only needs a specific portion of a web page to be protected.

Accordingly, what is needed is a method and system that is capable of preventing specific portions of web pages from being indexed by bots and/or other web crawling mechanisms. The method and system should be simple and capable of being easily adapted to existing technology. The present invention addresses these needs.

### SUMMARY OF THE INVENTION

A method and system for generating a web page is disclosed. Through the use of the present invention, specific content on a web page can be prevented from being indexed by a web crawling mechanism. This is beneficial for web page users the desire specific portions of a generated web page to remain private while at the same time keeping other portions of the web page available to be indexed.

Accordingly, a first aspect of the present invention is a method for generating a web page. The method includes designating content for publication on the web page; and designating a specific portion of the content to prevent a web crawling mechanism from indexing the specific portion.

A second aspect of the present invention is a computer system for generating a web page. The computer system includes a processor and an application program coupled to the processor wherein the application program is capable of designating information for publication on the web page and designating a specific portion of the information to prevent a web crawling mechanism from following the specific portion.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method in accordance with an embodiment of the present invention.

FIG. 2 is a block diagram representing a general purpose computer system in which aspects of embodiments of the present invention may be incorporated.

FIG. 3A is an example of a conventional web page.

FIG. 3B shows an alternate configuration of the web page in accordance with an embodiment of the present invention.

FIG. 3C shows an example of computer language that could be utilized in conjunction with an embodiment of the present invention.

FIG. 3D shows an alternate example of computer language that could be utilized in conjunction with an embodiment of the present invention.

FIG. 4 is a flowchart of program instructions that could be contained within a computer readable medium in accordance with the alternate embodiment of the present invention.

### DETAILED DESCRIPTION OF THE INVENTION

The present invention relates to a method and system for generating a web page. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

A method and system for generating a web page is disclosed. Through the use of the present invention, specific content on a web page can be prevented from being indexed by a web crawling mechanism. This is beneficial for web page users the desire specific portions of a generated web page to remain private while at the same time keeping other portions of the web page available to be indexed.

The present invention can be implemented in conjunction with server computers to locate and retrieve digital data on a network such as the Internet. A server computer on the Internet is sometimes referred to as a “Web site,” and the process of locating and retrieving digital data from Web sites is sometimes referred to as “Web crawling.” Web crawling may entail initially performing a first full crawl wherein a transaction log is “seeded” with one or more document address specifications. (The term address specification, address specifier, and URL are used interchangeably in this specification. These terms refer to any type of naming convention that may be used to address a file, and are not intended to imply that the present invention is limited to Internet applications.) Each document listed in the transaction log is retrieved from its Web site and processed. The processing may include extracting the data from each of these retrieved documents and storing that data in an index, or other database, with an associated “crawl number modified” that is set equal to a unique current crawl number that is associated with the first full crawl. A hash value (such as MD5) for the document and the document's time stamp may also be stored with the document data in the index. The document URL, its hash value, its time stamp, and its crawl number modified may then be stored in a persistent History Table used by the crawler to record documents that have been crawled.

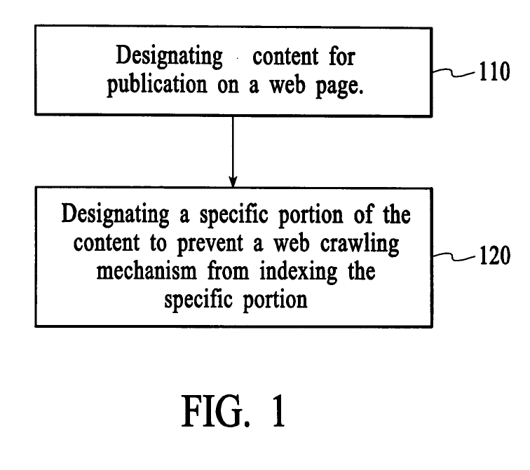

FIG. 1 shows a high-level flowchart of a method in accordance with an embodiment of the present invention. A first step 110 involves designating content for publication on the web page. For the purposes of this patent application, content includes text files coded in HTML, which may also contain JavaScript code or other commands. A final step 120 involves designating a specific portion of the content to prevent a web crawling mechanism from indexing the specific portion. Accordingly, specific portions of a generated web page are prevented from being indexed or followed and therefore are allowed to remain private.

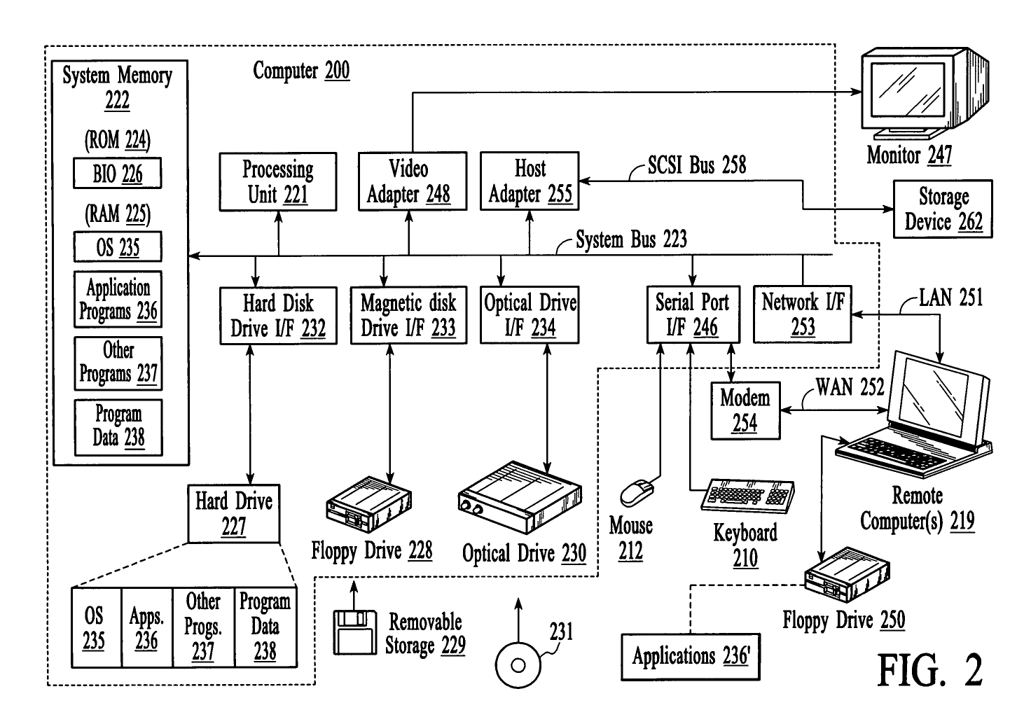

Web crawler programs execute on a computer. FIG. 2 and the following discussion are intended to provide a brief general description of a suitable computing environment in which the invention may be implemented. Although not required, the invention will be described in the general context of computer-executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 2, an exemplary general purpose computing system includes a conventional personal computer 200 or the like, including a processing unit 221, a system memory 222, and a system bus 223 that couples various system components including the system memory to the processing unit 221. The system bus 223 may be any of several types of bus structures including a memory bus or memory controller, a peripheral bus, and a local bus using any of a variety of bus architectures. The system memory includes read-only memory (ROM) 224 and random access memory (RAM) 225.

A basic input/output system 226 (BIOS), containing the basic routines that help to transfer information between elements within the personal computer 200, such as during start-up, is stored in ROM 224. The personal computer 200 may further include a hard disk drive 227 for reading from and writing to a hard disk, not shown, a magnetic disk drive 228 for reading from or writing to a removable magnetic disk 229, and an optical disk drive 230 for reading from or writing to a removable optical disk 231 such as a CD-ROM or other optical media. The hard disk drive 227, magnetic disk drive 228, and optical disk drive 230 are connected to the system bus 223 by a hard disk drive interface 232, a magnetic disk drive interface 233, and an optical drive interface 234, respectively. The drives and their associated computer-readable media provide non-volatile storage of computer readable instructions, data structures, program modules and other data for the personal computer 200.

Although the exemplary environment described herein employs a hard disk, a removable magnetic disk 229 and a removable optical disk 231, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 229, optical disk 231, ROM 224 or RAM 225, including an operating system 235, one or more application programs 236, other program modules 237 and program data 238. A user may enter commands and information into the personal computer 200 through input devices such as a keyboard 240 and pointing device 242. Other input devices (not shown) may include a microphone, joystick, game pad, satellite disk, scanner or the like. These and other input devices are often connected to the processing unit 221 through a serial port interface 246 that is coupled to the system bus, but may be connected by other interfaces, such as a parallel port, game port or universal serial bus (USB).

A monitor 247 or other type of display device is also connected to the system bus 223 via an interface, such as a video adapter 248. In addition to the monitor 247, personal computers typically include other peripheral output devices (not shown), such as speakers and printers. The exemplary system of FIG. 2 also includes a host adapter 255, Small Computer System Interface (SCSI) bus 256, and an external storage device 262 connected to the SCSI bus 256.

The personal computer 200 may operate in a networked environment using logical connections to one or more remote computers, such as a remote computer 249. The remote computer 249 may be another personal computer, a server, a router, a network PC, a peer device or other common network node, and typically includes many or all of the elements described above relative to the personal computer 200, although only a memory storage device 250 has been illustrated in FIG. 2. The logical connections depicted in FIG. 2 include a local area network (LAN) 251 and a wide area network (WAN) 252. Such networking environments are commonplace in offices, enterprise-wide computer networks, intranets and the Internet.

When used in a LAN networking environment, the personal computer 200 is connected to the LAN 251 through a network interface or adapter 253. When used in a WAN networking environment, the personal computer 200 typically includes a modem 254 or other means for establishing communications over the wide area network 252, such as the Internet. The modem 254, which may be internal or external, is connected to the system bus 223 via the serial port interface 246. In a networked environment, program modules depicted relative to the personal computer 200, or portions thereof, may be stored in the remote memory storage device. It will be appreciated that the network connections shown are exemplary and other means of establishing a communications link between the computers may be used.

As previously mentioned, the World Wide Web Consortium has published an HTML 4.01 reference. Within this version of HTML there is support for meta tags that specifically prevent bots from crawling or indexing a web page. However, varying embodiments of the present invention provide privacy at a finer granularity. Specifically, embodiments of the present invention allow bots a method of identifying specific content on a web page that should not be indexed or followed.

HTML documents are made up of HTML tags. HTML tags are made up of HTML attributes. The tags help define the HTML document, while attributes help define the tag. Accordingly, both tags and attributes could be utilized to help format an HTML document in accordance with the present invention.

The following are examples of HTML tags that could be utilized to designate specific content that is prevented from being indexed or followed by a bot:
<robot=“noindex, nofollow”>content</robot>
<robot=“noindex”>content</robot>
<robot=“nofollow”>content</robot>

By enclosing these tags around specific web page content, bots are prevented from indexing or following this content. Consequently, a web publisher could enclose an email address in these tags thereby preventing a bot from indexing the email address.

An alternate embodiment of the present invention would allow HTML tags to inherit attributes that would prevent bots from indexing or following specific content. The following are examples of HTML attributes that could be utilized to designate specific content is prevented from being indexed or followed by a bot:
robot=“noindex, nofollow”
robot=“noindex”
robot=“nofollow”

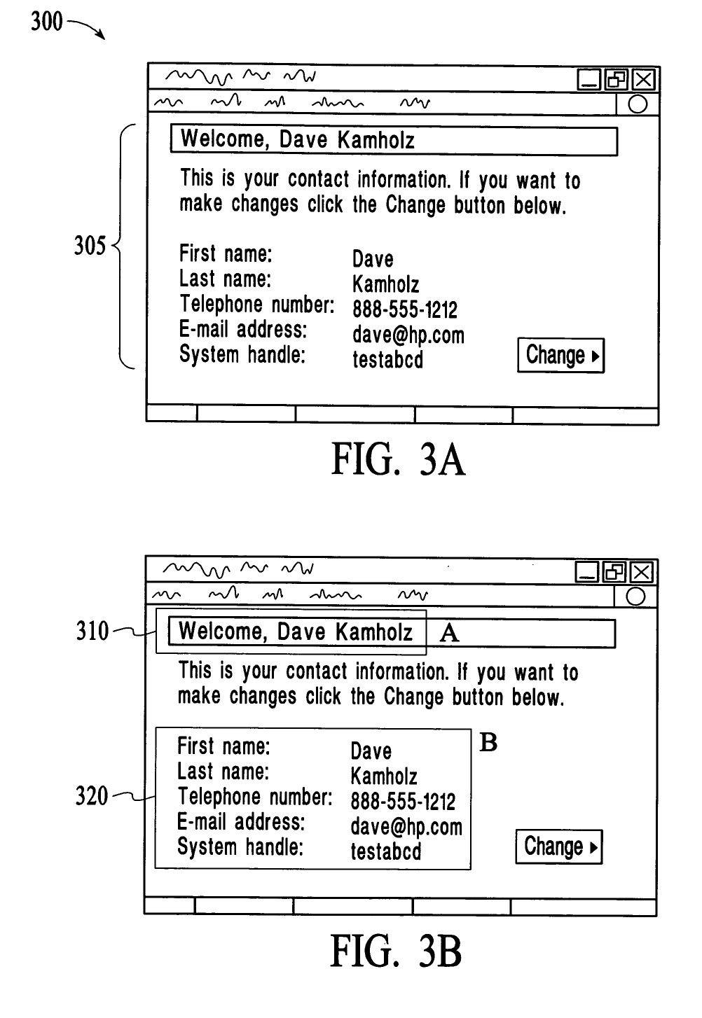

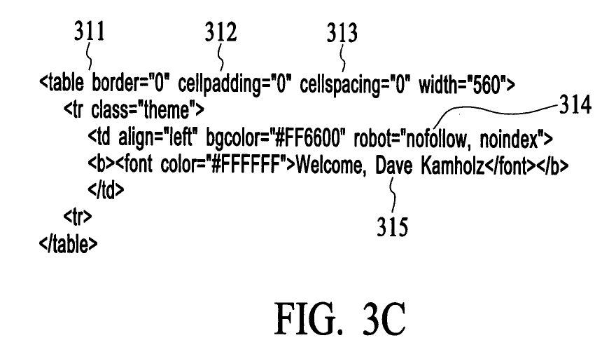

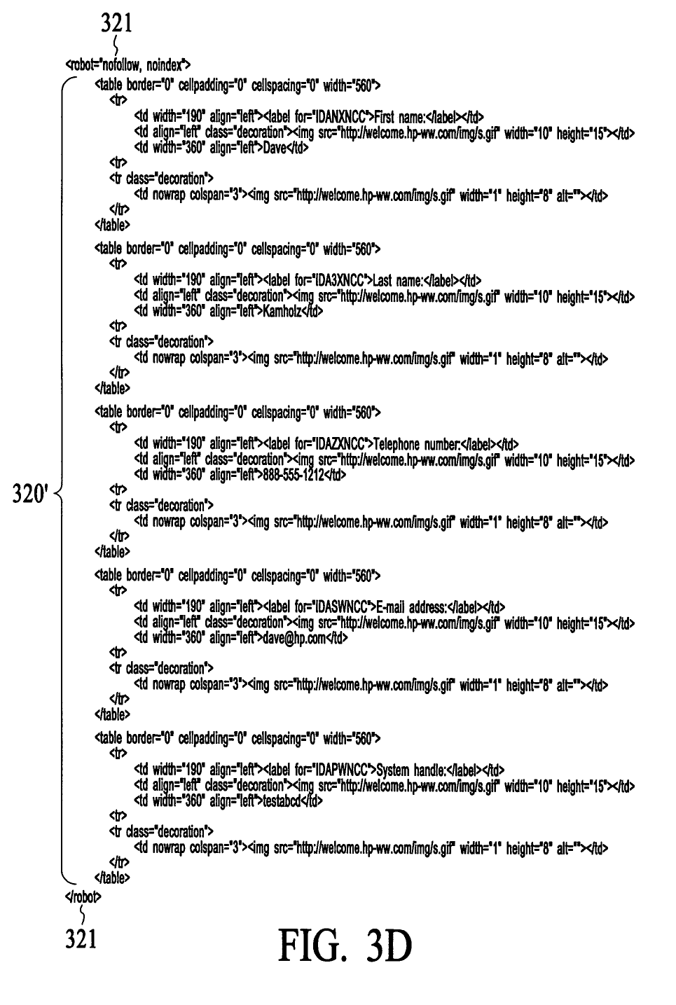

For a better understanding of the present invention, please refer to FIGS. 3A-3D. FIG. 3A shows a conventional web page 300. The web page 300 includes personal information 305. Accordingly, it is desirable to prevent a bot from following or indexing portions of the personal information 305.

In FIG. 3B, the personal information is separated into a section A 310 and a section B 320. FIG. 3C demonstrates how to utilize HTML attributes to prevent specific content from being followed by a bot in accordance with an embodiment of the present invention. The HTML code shown in FIG. 3C includes a tag 311, wherein the tag 311 includes a plurality of attributes 312, 313, 314. Accordingly, a bot recognizes attribute 314 as an indicator whereby specific content 315 associated with the attribute 314 is not to be followed or indexed. Consequently, the content in section A 310 is not followed or indexed by a bot.

Similarly, FIG. 3D demonstrates how to utilize HTML tags to prevent specific content from being followed by a bot in accordance with an embodiment of the present invention. HTML code 320′ corresponds to the personal information contained in section B 320 of FIG. 3C. Accordingly, a bot recognizes tag 321 as an indicator whereby specific content 320′ associated with the tag 321 is not to be followed or indexed. Consequently, the content in section B 320 is not followed or indexed by a bot.

Although the above-described embodiments are described in the context of being utilized in conjunction with an HTML computer language, one of ordinary skill in the art will readily recognize that a variety languages e.g. XML could be utilized while remaining within the spirit and scope of the present invention.

The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

This computer readable media may comprise, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

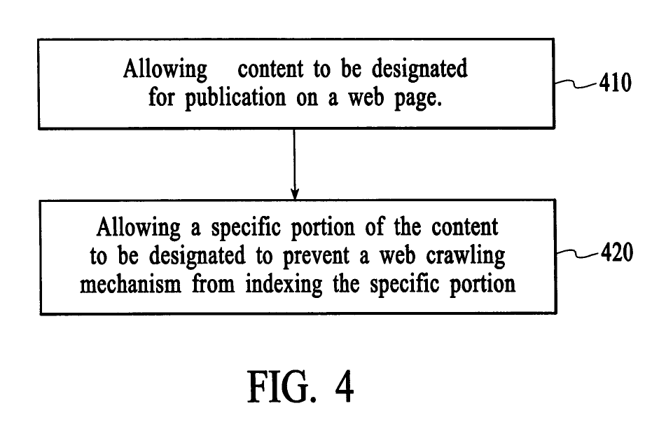

FIG. 4 is a flowchart of program instructions that could be contained within a computer readable medium in accordance with the alternate embodiment of the present invention. A first step 410 involves allowing content to be designated for publication on the web page. A final step 420 involves allowing a specific portion of the content to be designated to prevent a web crawling mechanism from indexing the specific portion.

A method and system for generating a web page is disclosed. Through the use of the present invention, specific content on a web page can be prevented from being indexed by a web crawling mechanism. This is beneficial for web page users the desire specific portions of a generated web page to remain private while at the same time keeping other portions of the web page available to be indexed.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method of generating a web page comprising:
designating content for publication on the web page; and
designating a specific portion of the content to prevent a web crawling mechanism from indexing the specific portion.

2. The method of claim 1 wherein designating a specific portion of the content further comprises:
utilizing a tag to designate the specific portion of content.

3. The method of claim 2 wherein the tag comprises a robot tag.

4. The method of claim 1 wherein designating a specific portion of the content further comprises:
utilizing an attribute to designate the specific portion of the content.

5. The method of claim 4 wherein the attribute comprises a robot attribute.

6. The method of claim 1 wherein indexing the specific content further comprises following the specific content.

7. A computer system for generating a web page comprising:
a processor;
an application program coupled to the processor wherein the application program is capable of;
designating information for publication on the web page; and
designating a specific portion of the information to prevent a web crawling mechanism from following the specific portion.

8. The system of claim 7 wherein designating a specific portion of the information further comprises:
implementing a tag to designate the specific portion of the information.

9. The system of claim 8 wherein the tag comprises a robot tag.

10. The system of claim 7 wherein designating a specific portion of the information further comprises:
implementing an attribute to designate the specific portion of the information.

11. The system of claim 10 wherein the attribute comprises a robot attribute.

12. The system of claim 7 wherein following the specific content further comprises indexing the specific content.

13. A computer program product for generating a web page, the computer program product comprising a computer usable medium having computer readable program means for causing a computer to perform the steps of:
allowing content to be designated for publication on the web page; and
allowing a specific portion of the content to be designated to prevent a web crawling mechanism from indexing the specific portion.

14. The computer program product of claim 13 wherein designating a specific portion of the content further comprises:
utilizing a tag to designate the specific portion of the content.

15. The computer program product of claim 14 wherein the tag comprises a robot tag.

16. The computer program product of claim 13 wherein designating a specific portion of the content further comprises:
utilizing an attribute to designate the specific portion of the content.

17. A method of generating a web page comprising:
designating content for publication on the web page;
utilizing a tag to designate a specific portion of the content to prevent a web crawling mechanism from indexing the specific portion wherein the tag comprises a robot tag.

18. The method of claim 17 wherein indexing further comprises following.

19. The method of claim 17 wherein utilizing a tag to designate a specific portion of the content further comprises:
utilizing an attribute to designate the specific portion of the content.

20. The method of claim 19 wherein the attribute comprises a robot attribute.
